(19) United States
(12) Patent Application Publication
(10) Pub. No.: US 2011/0090261 A1
(43) Pub. Date: Apr. 21, 2011

(54) BACKLIGHT UNIT FOR STABLY DRIVING VARIOUS LIGHT SOURCE MODULES AND DISPLAY APPARATUS USING THE SAME

(75) Inventors: Jeong-il KANG, Yongin-si (KR); Young-Deok CHOI, Seoul (KR); Hyo-Soon CHOI, Suwon-si (KR)

(73) Assignee: SAMSUNG ELECTRONICS CO., LTD., Suwon-si (KR)

(21) Appl. No.: 12/897,153

(22) Filed: Oct. 4, 2010

(30) Foreign Application Priority Data
Oct. 19, 2009 (KR) 10-2009-0099254

(51) Int. Cl. G09G 5/10; H05B 37/02

(52) U.S. Cl. 345/690; 315/294

(57) ABSTRACT

A backlight unit (BLU) capable of stably driving various light source modules, and a display apparatus using the same are provided. A display apparatus includes a display and a BLU. The BLU includes a light source module, a converter, a light source driving unit which drives the light source module using the output voltage of the converter, and a control unit which controls the output voltage of the converter based on the output voltage of the light source driving unit. Therefore, the ratio of the input voltage to the output voltage of the light source driving element may be maintained uniformly for various light source modules, so the light source modules can be stably driven.

### CROSS-REFERENCE TO RELATED APPLICATION

This application claims priority from Korean Patent Application No. 10-2009-0099254, filed on Oct. 19, 2009 in the Korean Intellectual Property Office, the disclosure of which is incorporated herein by reference in its entirety.

### BACKGROUND

1. Field

Apparatuses and methods consistent with the exemplary embodiments relate to a backlight unit (BLU) and a display apparatus using the same, and more particularly, to a BLU for providing a display unable to emit light by itself with backlight, and a display apparatus using the same.

2. Description of the Related Art

Liquid crystal displays (LCDs), which are commonly used displays, cannot emit light by themselves, so an LCD module requires a BLU to emit backlight.

A BLU consists of light sources for generating backlight and a driving element for driving the light sources. The light sources are divided into modules and the number of light sources mounted in a single light source module varies according to the size of an LCD.

The driving element should be designed differently for each light source module. This is because the number of light sources mounted in each single light source module is different, so the voltage required to drive each single light source module is also different.

Accordingly, in order to more stably operate the driving element, the driving element should be designed differently for each light source module. However, designing the driving element may be difficult.

Therefore, there is a need for a BLU capable of stably driving various light source modules.

### SUMMARY

Exemplary embodiments address at least the above problems and/or disadvantages and other disadvantages not described above. Also, an exemplary embodiment is not required to overcome the disadvantages described above, and an exemplary embodiment may not overcome any of the problems described above.

One or more exemplary embodiments provide a BLU capable of stably driving various light source modules, and a display apparatus using the same.

According to an aspect of an exemplary embodiment, there is provided a display apparatus including a display which displays an image, and a BLU which provides backlight to the display, wherein the BLU includes a light source module which generates the backlight using a plurality of light sources, a converter which outputs an output voltage by transforming an input voltage, a light source driving unit which drives the light source module using the output voltage of the converter, and a control unit which controls the output voltage of the converter based on an output voltage of the light source driving unit.

If the output voltage of the light source driving unit increases, the control unit may increase the output voltage of the converter, and if the output voltage of the light source driving unit decreases, the control unit may decrease the output voltage of the converter.

The converter may adjust a transformation ratio of the input voltage according to an input control signal, and the control unit may adjust the control signal based on the output voltage of the light source driving unit and output the adjusted control signal to the converter.

The control unit may include an adjuster which generates the control signal by adjusting the output voltage of the light source driving unit.

The control unit may further include a divider which divides the output voltage of the light source driving unit, and the adjuster may generate the control signal by adjusting the output voltage of the light source driving unit which is divided by the divider.

The control unit may include a quantizer which generates the control signal by quantizing the output voltage of the light source driving unit.

The control unit may further include a processor which hysteresis-processes the output voltage of the light source driving unit, and the quantizer may quantize the output voltage of the light source driving unit which is hysteresis-processed by the processor.

The output voltage of the light source driving unit may vary according to a number of the plurality of light sources in the light source module.

The converter may output the output voltage to be proportional to the output voltage of the light source driving unit according to the operation of the control unit.

According to an aspect of another exemplary embodiment, there is provided a BLU including a light source module which generates backlight using a plurality of light sources, a converter which outputs an output voltage by transforming an input voltage, a light source driving unit which drives the light source module using the output voltage of the converter, and a control unit which controls the output voltage of the converter based on an output voltage of the light source driving unit.

If the output voltage of the light source driving unit increases, the control unit may increase the output voltage of the converter, and if the output voltage of the light source driving unit decreases, the control unit may decrease the output voltage of the converter.

The converter may adjust a transformation ratio of the input voltage according to an input control signal, and the control unit may adjust the control signal based on the output voltage of the light source driving unit and output the adjusted control signal to the converter.

The control unit may include an adjuster which generates the control signal by adjusting the output voltage of the light source driving unit.

The control unit may further include a divider which divides the output voltage of the light source driving unit, and the adjuster may generate the control signal by adjusting the output voltage of the light source driving unit which is divided by the divider.

The control unit may include a quantizer which generates the control signal by quantizing the output voltage of the light source driving unit.

The control unit may further include a processor which hysteresis-processes the output voltage of the light source driving unit, and the quantizer may quantize the output voltage of the light source driving unit which is hysteresis-processed by the processor.

The output voltage of the light source driving unit may vary according to a number of the plurality of light sources in the light source module.

The converter may output the output voltage to be proportional to the output voltage of the light source driving unit according to the operation of the control unit.

### BRIEF DESCRIPTION OF THE DRAWINGS

The above and/or other aspects will be more apparent by describing certain exemplary embodiments with reference to the accompanying drawings, in which:

FIG. 1 is a block diagram of a display device according to an exemplary embodiment;

FIG. 2 is a detailed block diagram of a BLU of the display device shown in FIG. 1 according to an exemplary embodiment;

FIG. 3 is a block diagram illustrating an output voltage control unit of the BLU shown in FIG. 2 according to an exemplary embodiment;

FIG. 4 is a block diagram illustrating an output voltage control unit of the BLU shown in FIG. 2 according to another exemplary embodiment; and

FIG. 5 is a block diagram illustrating an output voltage control unit of the BLU shown in FIG. 2 according to another exemplary embodiment.

### DETAILED DESCRIPTION OF EXEMPLARY EMBODIMENTS

Certain exemplary embodiments will now be described in greater detail with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiments with unnecessary detail.

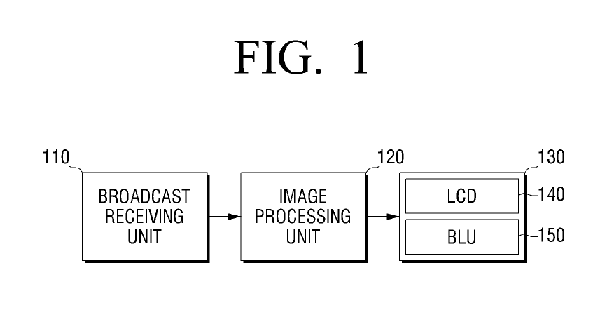

FIG. 1 is a block diagram of a display device according to an exemplary embodiment. In FIG. 1, the display device is an LCD television (TV). However, the inventive concept is not limited thereto. As illustrated in FIG. 1, the LCD TV according to an exemplary embodiment may include a broadcast receiving unit 110, an image processing unit 120, and an LCD module 130.

The broadcast receiving unit 110 receives broadcasting content from broadcasting stations, satellites, or external devices which are connected to an external input terminal via a cable or wirelessly, and demodulates the received broadcasting content.

The image processing unit 120 performs signal-processing, such as video decoding, video scaling, frame rate conversion (FRC), etc, of the broadcasting content output by the broadcast receiving unit 110.

The LCD module 130 may include an LCD 140 and a BLU 150. The LCD 140 displays the broadcasting content processed by the image processing unit 130.

The BLU 150 projects backlight onto the LCD 140. Since the LCD 140 cannot emit light by itself, the BLU 150 is required. The BLU 150 may be formed in edge LED sets which may be formed at the edge of the LCD TV, or may also be formed in direct LED sets.

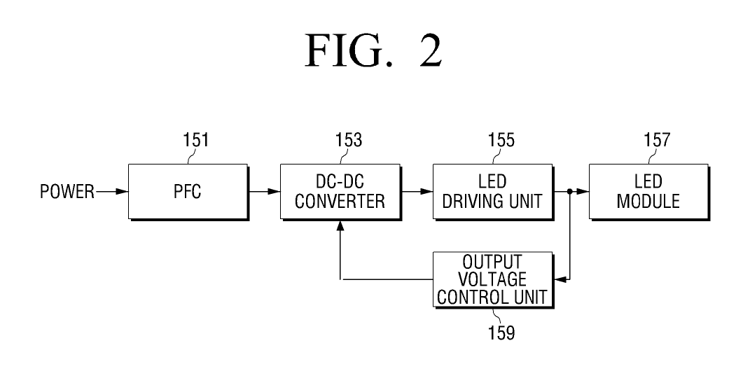

Hereinafter, the BLU 150 is described in detail with reference to FIG. 2.

FIG. 2 illustrates the BLU 150 shown in FIG. 1 according to an exemplary embodiment. As illustrated in FIG. 2, the BLU 150 includes a power factor corrector (PFC) 151, a DC-DC converter 153, an LED driving unit 155, an LED module 157, and an output voltage control unit 159.

The LED module 157 is a module formed by arraying LEDs, which generate backlight projected from the BLU 150 onto the LCD 140, in series. If the LEDs are arrayed in series, it is possible to effectively reduce the number of the DC-DC converters 153 and the LED driving units 155 which are necessary to drive the LED module 157.

The number of LEDs in the LED module 157 depends on the size of the LCD 140. Since the LED module 157 includes a plurality of LEDs, the voltage applied to the LED module 157 ranges from dozens of voltages to hundreds of voltages.

The PFC 151 is a circuit that appropriately adjusts a power factor of the BLU 150 for improvement of the power factor.

The DC-DC converter 153 transforms the voltage of input power and outputs the transformed voltage to an input terminal of the LED driving unit 155. The DC-DC converter 153 may be implemented as a flyback circuit, a resonant circuit, or an insulating transformer.

The LED driving unit 155 drives the LED module 157 using the output voltage of the DC-DC converter 153 as an input voltage. The LED driving unit 155 may be implemented in a boost scheme in which a switching element for adjusting a duty ratio of the driving current to drive the LED module 157 is driven based on grounding.

In order to maintain the brightness of backlight emitted from the LED module 157 uniformly, the LED driving unit 155 outputs a constant current. As the LED driving unit 155 outputs a constant current, the output voltage of the LED driving unit 155 depends on the voltage applied to the LED module 157 operating as a load.

As described above, the number of LEDs in the LED module 157 may vary. Since the constant current is supplied to the LED module 157, the voltage applied to the LED module 157 is proportional to the number of LEDs in the LED module 157. Consequently, the output voltage of the LED driving unit 155 is proportional to the number of LEDs in the LED module 157.

If the ratio of the input voltage to the output voltage of the LED driving unit 155 is far from 1, the efficiency of the LED driving unit 155 decreases and heat from elements in the LED driving unit 155 increases. Accordingly, it may be desirable to maintain the ratio of the input voltage to the output voltage of the LED driving unit 155 at or near 1.

Since the output voltage of the LED driving unit 155 depends on the voltage applied to the LED module 157 as described above, it is not appropriate to adjust the output voltage of the LED driving unit 155. Accordingly, the input voltage of the LED driving unit 155 needs to be adjusted based on the output voltage of the LED driving unit 155.

The LED driving unit 155 receives power from the DC-DC converter 153, so the input voltage of the LED driving unit 155 corresponds to the output voltage of the DC-DC converter 153. Therefore, in order to change the input voltage of the LED driving unit 155, the output voltage of the DC-DC converter 153 needs to change.

To this end, the output voltage control unit 159 senses the output voltage of the LED driving unit 155 and controls the output voltage of the DC-DC converter 153 based on the sensing result. More specifically, the output voltage control unit 159 senses the output voltage of the LED driving unit 155 and feeds the sensing result back to the DC-DC converter 153 so as to control the DC-DC converter 153.

That is, the output voltage control unit 159 adjusts a control signal to be proportional to the output voltage of the LED driving unit 155 and feeds the control signal back to the DC-DC converter 153. The DC-DC converter 153 adjusts the output voltage by adjusting a transformation ratio of the power input to the DC-DC converter 153 to the output voltage according to the control signal.

Accordingly, if the output voltage of the LED driving unit 155 increases, the output voltage of the DC-DC converter 153 increases, and if the output voltage of the LED driving unit 155 decreases, the output voltage of the DC-DC converter 153 decreases.

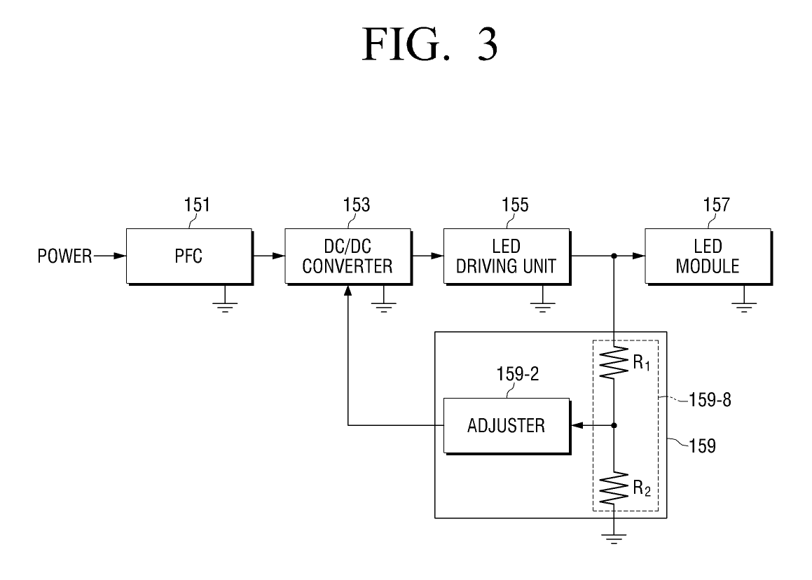

Hereinafter, exemplary methods for implementing the output voltage control unit 159 are described in detail with reference to FIGS. 3 to 5.

FIG. 3 illustrates an example of output voltage control unit 159. The output voltage control unit 159 in FIG. 3 may include an adjuster 159-2 and a voltage divider 159-8.

The voltage divider 159-8 may be implemented as a voltage dividing circuit including two resistors R1 and R2. The voltage divider 159-8 transmits the output voltage of the LED driving unit 155 to the adjuster 159-2.

The adjuster 159-2 generates a control signal by adjusting the voltage input by the voltage divider 159-8 and transmits the generated control signal to the DC-DC converter 153. More specifically, the adjuster 159-2 generates a control signal to be proportional to the voltage input by the voltage divider 159-8. To this end, the adjuster 159-2 may add a gain and an offset to the voltage input by the voltage divider 159-8.

That is, the adjuster 159-2 generates the voltage (y) of the control signal as ax+b, where ‘x’ is the voltage input by the voltage divider 159-8, ‘a’ is the gain, and ‘b’ is the offset.

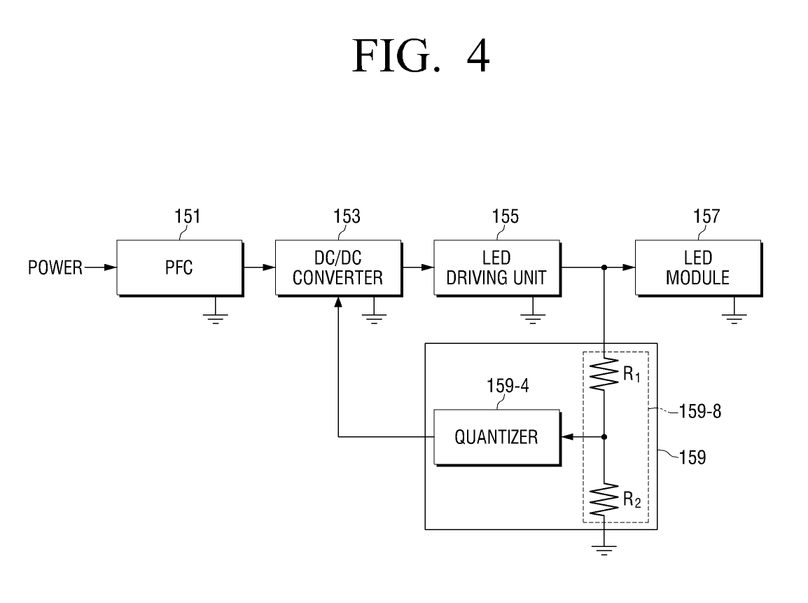

FIG. 4 illustrates another example of output voltage control unit 159. The output voltage control unit 159 in FIG. 4 may include a quantizer 159-4 and a voltage divider 159-8.

The voltage divider 159-8 in FIG. 4 is the same as the voltage divider 159-8 in FIG. 3, so detailed description thereof is not repeated.

The quantizer 159-4 generates a control signal by quantizing the voltage input by the voltage divider 159-8 and transmits the generated control signal to the DC-DC converter 153.

If the output voltage control unit 159 is implemented using the quantizer 159-4, the output voltage of the DC-DC converter 153 does not change continuously but changes discretely. Accordingly, the output voltage of the DC-DC converter 153 may not change frequently, so stability of the entire circuit of the BLU 150 can be improved.

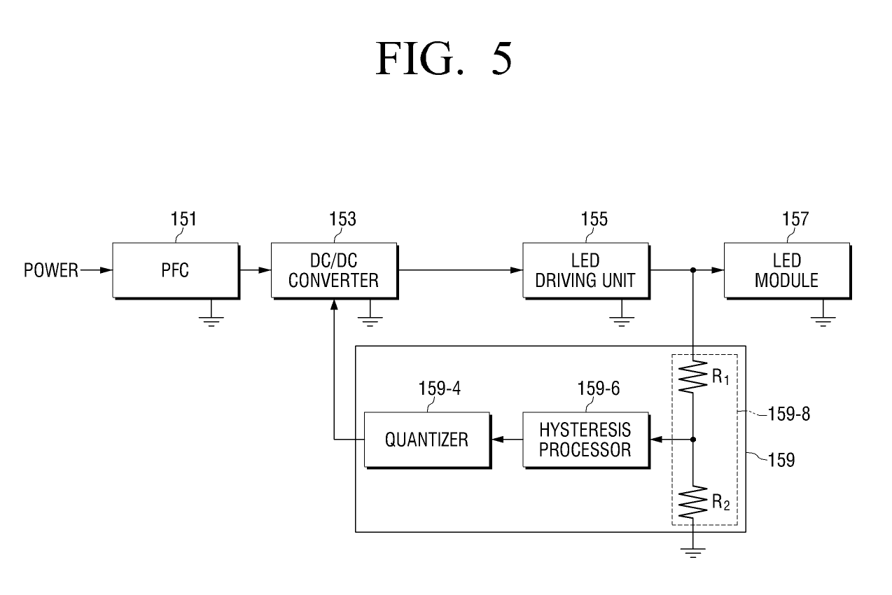

FIG. 5 illustrates yet another example of output voltage control unit 159. The output voltage control unit 159 in FIG. 5 may include a quantizer 159-4, a hysteresis processor 159-6, and a voltage divider 159-8.

The voltage divider 159-8 in FIG. 5 is the same as the voltage divider 159-8 in FIG. 3, so detailed description is not repeated.

The hysteresis processor 159-6 hysteresis-processes the voltage input by the voltage divider 159-8.

The quantizer 159-4 generates a control signal by quantizing the voltage processed by the hysteresis processor 159-6 and transmits the generated control signal to the DC-DC converter 153.

As illustrated in FIG. 5, if the hysteresis processor 159-6 is added to an input terminal of the quantizer 159-4, chattering at a boundary point of quantization may be prevented and thus stability of the entire circuit of the BLU 150 may be further improved.

A BLU capable of stably driving various light source modules, and a display apparatus using the same have been described above in detail with reference to the exemplary embodiments.

In the exemplary embodiments, the LED driving unit 155 may be implemented using a boost scheme, but this is merely an example. For example, the LED driving unit 155 may be implemented using other schemes such as a buck scheme.

In the exemplary embodiments, the LED is merely an example of light source. The inventive concept of the exemplary embodiments can also be applied to other types of light sources.

As can be appreciated from the above description, the output voltage of a converter which provides power to a light source driving element can be controlled based on the output voltage of the light source driving element which drives a light source module. Therefore, the ratio of the input voltage to the output voltage of the light source driving element may be maintained uniformly whatever the light source module is.

Accordingly, even if various light source modules are used, the inconvenience of differently designing the light source driving element can be prevented. Furthermore, even if the properties of the light source module change due to long usage or due to a short circuit in some of the light sources in the light source module, the light source module can be driven stably.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display which displays an image; and
a backlight unit (BLU) which provides light to the display,
wherein the BLU comprises:
a light source module which comprises a plurality of light sources that generate the light provided to the display;
a converter which outputs a first voltage by transforming an input voltage;
a light source driving unit which receives the first voltage output by the converter, and outputs a second voltage to drive the light source module based on the first voltage output by the converter; and
a control unit which controls the first voltage output by the converter based on the second voltage output by the light source driving unit.

2. The display apparatus according to claim 1, wherein if the second voltage increases, the control unit controls the converter to increase the first voltage, and if the second voltage decreases, the control unit controls the converter to decrease the first voltage.

3. The display apparatus according to claim 1, wherein the control unit generates a control signal based on the second voltage output by the light source driving unit and outputs the control signal to the converter, and the converter adjusts a transformation ratio of the input voltage according to the control signal.

4. The display apparatus according to claim 3, wherein the control unit comprises:
an adjuster which generates the control signal by adjusting the second voltage output by the light source driving unit.

5. The display apparatus according to claim 4, wherein the control unit further comprises:
a divider circuit which divides the second voltage output by the light source driving unit to generate a third voltage, and
wherein the adjuster generates the control signal by adjusting the third voltage.

6. The display apparatus according to claim 3, wherein the control unit comprises:
a quantizer which generates the control signal by quantizing the second voltage output by the light source driving unit.

7. The display apparatus according to claim 6, wherein the control unit further comprises:
a processor which hysteresis-processes the second voltage output by the light source driving unit, and
wherein the quantizer quantizes the second voltage output by the light source driving unit which is hysteresis-processed by the processor.

8. The display apparatus according to claim 1, wherein the second voltage output by the light source driving unit varies according to a number of the plurality of light sources in the light source module.

9. The display apparatus according to claim 1, wherein the converter outputs the first voltage to be proportional to the second voltage according to an operation of the control unit.

10. A backlight unit (BLU) comprising:
a light source module which generates light using a plurality of light sources;
a converter which outputs a first voltage by transforming an input voltage;
a light source driving unit which receives the first voltage output by the converter, and outputs a second voltage to drive the light source module based on the second voltage output by the converter; and
a control unit which controls the first voltage output by the converter based on the second voltage output by the light source driving unit.

11. The BLU according to claim 10, wherein if the second voltage output by the light source driving unit increases, the control unit controls the converter to increase the first voltage, and if the second voltage decreases, the control unit controls the converter to decrease the first voltage.

12. The BLU according to claim 10, wherein the control unit generates a control signal based on the second voltage output by the light source driving unit and outputs the control signal to the converter, and the converter adjusts a transformation ratio of the input voltage according to the control signal.

13. The BLU according to claim 12, wherein the control unit comprises:
an adjuster which generates the control signal by adjusting the second voltage output by the light source driving unit.

14. The BLU according to claim 13, wherein the control unit further comprises:
a divider circuit which divides the second voltage output by the light source driving unit to generate a third voltage, and
wherein the adjuster generates the control signal by adjusting the third voltage.

15. The BLU according to claim 12, wherein the control unit comprises:
a quantizer which generates the control signal by quantizing the second voltage output by the light source driving unit.

16. The BLU according to claim 15, wherein the control unit further comprises:
a processor which hysteresis-processes the second voltage output by the light source driving unit, and
wherein the quantizer quantizes the second voltage output by the light source driving unit which is hysteresis-processed by the processor.

17. The BLU according to claim 10, wherein the second voltage output by the light source driving unit varies according to a number of the plurality of light sources in the light source module.

18. The BLU according to claim 10, wherein the converter outputs the first voltage to be proportional to the second voltage according to an operation of the control unit.

19. A method of providing backlight to a display, the method comprising:
generating the backlight using a plurality of light sources in a light source module;
transforming an input voltage into a first voltage;
producing a second voltage from the first voltage;
driving the light source module using the second voltage; and
controlling the first voltage based on the second voltage.

20. The method of claim 19, wherein the controlling comprises increasing the first voltage if the second voltage increases, and decreasing the first voltage if the second voltage decreases.

21. The method of claim 19, further comprising:
generating a control signal based on the second voltage; and
adjusting a transformation ratio of the input voltage according to the control signal.

22. The method of claim 21, further comprising:
dividing the second voltage to produce a third voltage; and
generating the control signal by adjusting the third voltage.

23. The method of claim 21, wherein the generating the control signal comprises quantizing the second voltage.

24. The method of claim 21, wherein the generating the control signal comprises hysteresis processing the second voltage and quantizing the hysteresis-processed second voltage.
